(19) United States
(12) Patent Application Publication
(10) Pub. No.: US 2016/0274268 A1
(43) Pub. Date: Sep. 22, 2016

(54) POLYCRYSTALLINE TRANSPARENT CERAMICS FOR USE WITH A LOGGING SENSOR OR TOOL

(71) Applicant: HALLIBURTON ENERGY SERVICES, INC., Houston, TX (US)

(72) Inventors: Robert S. Atkinson, Richmond, TX (US); David L Perkins, The Woodlands, TX (US); Michael T. Pelletier, Houston, TX (US); Christopher Michael Jones, Houston, TX (US); Wei Zhang, Houston, TX (US); Li Gao, Katy, TX (US)

(73) Assignee: HALLIBURTON ENERGY SERVICES, INC., Houston, TX (US)

(21) Appl. No.: 15/034,160

(22) PCT Filed: Dec. 9, 2013
(86) PCT No.: PCT/US2013/073840

§ 371 Date: May 3, 2016

(51) Int. Cl. G01V 8/12

(52) U.S. Cl. CPC G01V 8/12

(57) ABSTRACT

The disclosure relates to logging sensor or tool including an electromagnetic radiation source operable to emit at least one wavelength of electromagnetic radiation, a detector operable to detect the wavelength of electromagnetic radiation, a polycrystalline transparent ceramic component transparent to the wavelength of radiation, and a flowline between the electromagnetic radiation source and the detector having at least a portion of a wall formed from the polycrystalline transparent ceramic component, the flow line operable to permit the flow of a drilling fluid. Such a sensor may be used in a logging while drilling or measuring while drilling apparatus. The also disclosure relates to a wireline measurement apparatus including a sensor comprising a polycrystalline transparent ceramic component. The disclosure further relates to a cast logging sensor or tool component comprising a polycrystalline transparent ceramic component, wherein the sensor component has a shape not obtainable from a single crystal using machining techniques.

### TECHNICAL FIELD

The present disclosure relates to polycrystalline transparent ceramics for use with a logging sensor or tool. In a specific embodiment, it relates to polycrystalline aluminum oxynitride (ALON) for use with a logging sensor or tool. The present disclosure also relates to a logging sensor or tool or a logging sensor or tool component containing a polycrystalline transparent ceramic.

### BACKGROUND

During drilling operations, such as during the drilling of an oil well, it is often helpful to obtain information about conditions downhole in the well. For instance, information about the formation characteristics is often obtained using various measurement techniques, such as logging while drilling (LWD), measuring while drilling (MWD), and wireline tests. Various properties may also be measured using such techniques. For example, properties of downhole fluids may be measured.

In order to effect downhole measurements, a variety of sensors are often used. The sensing components of these sensors are normally not able to withstand downhole conditions. As a result, sensors are normally provided with a protective component that both protects the sensing components and is transparent to electromagnetic wavelengths sensed by the sensing components. These protective components are currently often formed from sapphire, which is a single crystal aluminum oxide. However, sapphire cannot be easily shaped or attached to other sensor or downhole components.

### BRIEF DESCRIPTION OF THE DRAWINGS

For a more complete understanding of certain embodiments of the present disclosure and their features and advantages, reference is now made to the following description, taken in conjunction with the accompanying drawings, in which:

FIG. 1 illustrates a cross-section of a sensor including a polycrystalline transparent ceramic component;

FIG. 2 illustrates a block diagram of features of a system that employs a polycrystalline transparent ceramic component to acquire optical data from a reservoir fluid in a wellbore;

FIG. 3A illustrates a sensor component including a polycrystalline transparent ceramic containing a mandrel;

FIG. 3B illustrates a sensor component including a polycrystalline transparent ceramic containing a pressure-balanced fluid window;

FIG. 4 illustrates a cross-section of a polycrystalline transparent ceramic component with grooves;

FIG. 5 illustrates a cross-section of a polycrystalline transparent ceramic component with brazing;

FIG. 6 illustrates a cross-section of a polycrystalline transparent ceramic component with brazing and a gap between the component and housing;

FIG. 7 illustrates a cross-section of a polycrystalline transparent ceramic component shaped to intensity electromagnetic radiation passing through it;

FIG. 8 illustrates a cross-section of a sensor with a sapphire component and brazing material and with a polycrystalline transparent ceramic layer;

FIG. 9A is a diagram showing an illustrative logging while drilling environment; and

FIG. 9B is a diagram showing an illustrative wireline logging environment.

### DETAILED DESCRIPTION

The present disclosure relates to polycrystalline transparent ceramics for use with a logging sensor or tool. The present disclosure also relates to a logging sensor or tool or a logging sensor or tool component containing a polycrystalline transparent ceramic.

As used herein, the term “optical computing device” refers to an optical device that is configured to receive an input of electromagnetic radiation associated with a substance, such as a fluid and produce an output of electromagnetic radiation from a processing element arranged within the optical computing device. The processing element may be, for example, an integrated computational element (ICE) used in the optical computing device. The electromagnetic radiation that optically interacts with the processing element is changed so as to be readable by a detector, such that an output of the detector can be correlated to a characteristic of the fluid or a phase of the fluid. The output of electromagnetic radiation from the processing element can be reflected electromagnetic radiation, transmitted electromagnetic radiation, and/or dispersed electromagnetic radiation. Whether the detector analyzes reflected, transmitted, or dispersed electromagnetic radiation may be dictated by the structural parameters of the optical computing device as well as other considerations known to those skilled in the art. In addition, emission and/or scattering of the fluid or a phase thereof, for example via fluorescence, luminescence, Raman, Mie, and/or Raleigh scattering, can also be monitored by the optical computing devices.

As used herein, the term “characteristic” refers to a chemical, mechanical, or physical property of a substance and may be used herein interchangeably with the phrase “analyte of interest.” Illustrative characteristics of a substance that can be monitored with the optical computing devices disclosed herein can include, for example, chemical composition (identity and concentration, in total or of individual components), impurity content, pH, viscosity, density, ionic strength, total dissolved solids, salt content, porosity, opacity, bacteria content, combinations thereof, and the like.

### Polycrystalline Transparent Ceramics

In a specific embodiment, the polycrystalline transparent ceramic may include or be formed substantially from polycrystalline aluminum oxynitride (ALON). ALON is an isotropic material with a spinel crystal structure stabilized by incorporation of nitrogen into aluminum oxide. ALON has a general chemical formula of Al₂₃O₂₇N₅. ALON is typically transparent to electromagnetic radiation with wavelengths from the ultraviolet to the mid-infrared range (10 nm to 7000 nm), including the ultraviolet range (10 nm to 380 nm), the visible range (380 nm to 700 nm), the near-infrared range (700 nm to 1400 nm), the short wavelength infrared range (1400 nm to 3000 nm), and the mid-infrared range (3000 nm to 7000 nm). ALON may be equivalent to sapphire in its optical qualities and also similarly exhibits low density, high strength, and high durability. Like sapphire, ALON may also be chemically resistant. ALON may also generally be subjected to greater tension without breaking than sapphire may be.

Because ALON is an isotropic material, it is generally uniform in all directions and may not experience problems with refractive index along certain axes, such as problems exhibited with respect to the C axis in sapphire. ALON may be used without a calcium fluoride component, avoiding optical reflection losses associated with calcium fluoride may be avoided and a sensor containing ALON in place of a sapphire/calcium fluoride component may have at least a 7% increase in optical throughput.

Due to its polycrystalline nature ALON may be shaped into complex geometries during its casting process. Various casting techniques may be used to form ALON, including hot pressing and slip casting. Other conventional methods for forming polycrystalline materials from powder may also be used with ALON.

In another specific embodiment, the polycrystalline transparent ceramic may include or be formed substantially from polycrystalline magnesium aluminate spinel. Magnesium aluminate spinel has a general chemical formula of MgAl2O4 with a spinel crystal structure. Magnesium aluminate spinel is typically transparent to electromagnetic radiation with wavelengths from 200 nm to 5500 nm. Magnesium aluminate spinel may exhibit superior optical properties in the infrared range (700 nm to 8000 nm) as compared to ALON.

Magnesium aluminate spinel may also be shaped into complex geometries during its casting process using conventional method for forming polycrystalline materials from powder, such as sinter/hot isostatic pressing (HIP), hot pressing, and hot pressing/HIP methods. The use of HIP method with magnesium aluminate spinel may improve its optical and physical properties. Magnesium aluminate spinel may be formed into particular geometries at a lower temperature than that typically required for ALON.

In other embodiments, the polycrystalline ceramic material may include or be formed substantially from magnesium oxide, yttrium oxide, aluminum oxide, aluminum nitride, silicon carbide, boron nitride, silicon nitride, boron carbide, silicon oxide, titanium carbide, titanium nitride, or zirconium silicon oxide.

The polycrystalline ceramic material may include or be formed substantially from a combination of at least two of any of the above materials. The polycrystalline ceramic material may be a nanocomposite.

### Logging Sensors or Tools and Components

In another embodiment, the disclosure relates to a component for use in a logging sensor or tool, the component containing a polycrystalline transparent ceramic, such as ALON or magnesium aluminate spinel. The disclosure further relates to a logging sensor or tool containing such components.

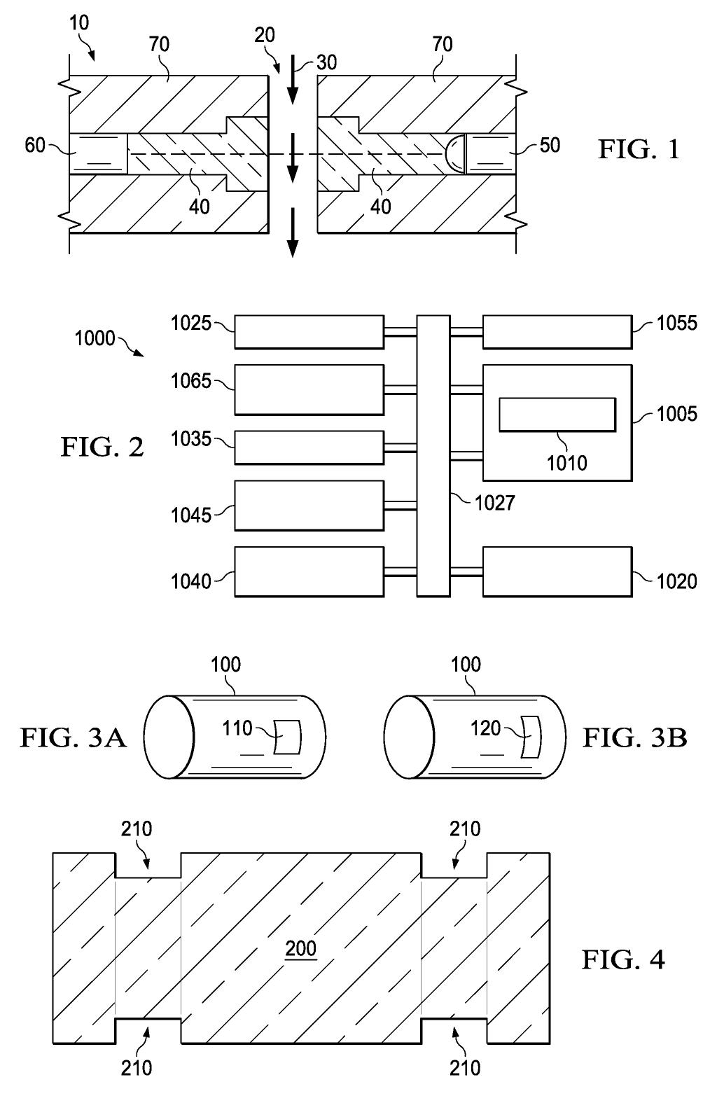

One example component and logging sensor or tool are shown in FIG. 1. Logging sensor or tool 10 contains passage 20 through which downhole fluid 30 flows. Logging sensor or tool 10 also contains polycrystalline transparent ceramic components 40 located in passage 20 and housed in housing 70. Housing 70 and other sensor housing described herein may be any material suitable for use downhole, such as a metal, in particular titanium. Electromagnetic radiation source 50 provides electromagnetic radiation which is transmitted through and optically interacts with downhole fluid 30 and may be detected by detector 60. Electromagnetic radiation source 50 may, for example, include a tungsten filament light source. Radiation source 50 provides at least one wavelength of electromagnetic radiation. Although not expressly shown in all embodiments, other sensors of this disclosure may also contain an electromagnetic radiation source.

Electromagnetic radiation from electromagnetic source 50 may pass through polycrystalline transparent ceramic components 40 to reach detector 60. Accordingly, these components 40 may be between source 50 and detector 60. They need not, however, be located so as to allow a straight line path for the electromagnetic radiation from source 50 to detector 60. For example, passage 20 may include a reflective component (not shown) that may alter the path of the electromagnetic radiation. Alternatively, components 40 may be configured to alter the path of electromagnetic radiation in passage 20 from the either the source 50 (collecting and/or collimating) or to the detector 60 (focusing) in the form of an optical lens.

Properties of fluid 30 may be analyzed measuring the effects of the fluid 30 on electromagnetic radiation passing from source 50 to detector 60. Although not expressly shown, other sensors of this disclosure may also contain a detector. Also not expressly shown, other optical components may be included in the sensor to allow for the properties of the fluid 30 to be measured. Other components include, but are not limited to, filter photometers, spectrometers, optical gratings, optical filters, integrated computational elements (ICE), and other sensor components not related specifically to interact with the fluid 30 or to alter the path of electromagnetic radiation from the source to the detector.

A detector may be able to detect at least one wavelength or range of electromagnetic radiation from source 50 and may be able to separately detect multiple wavelengths. Alternatively, detector 60 may contain sub-detectors, each able to detect a certain wavelength or range of wavelengths of electromagnetic radiation. A detector may contain or be in communication with a processor and data storage device as well as an output device. The data storage device or output device may be located downhole or at the surface. The polycrystalline transparent ceramic may be transparent to at least one wavelength emitted by source 50 and detected by detector 60.

FIG. 2 depicts a block diagram of features of an embodiment of an example system 1000 that employs a polycrystalline transparent ceramic component to acquire optical data from a reservoir fluid in a wellbore. The system 1000 includes one or more evaluation tools 1005, such as a logging sensor or tool, having at least one sensor 1010 able to make measurements with respect to a wellbore. The system 1000 may also include a controller 1025, a memory 1035, an electronic apparatus 1065, or a communications unit 1040. The controller 1025 or the memory 1035 may be arranged to operate the one or more evaluation tools 1005 or to acquire measurement data as the one or more evaluation tools 1005 are operated. The controller 1025 or the memory 1035 may control activation and data acquisition of the at least one sensor 1010 or to manage processing schemes with respect to data as described herein. Memory 1035 may include at least one machine-readable storage device having instructions stored thereon, which, when performed by a machine, cause the machine to perform operations including correlation of data or a statistical analysis of data as taught herein. Processing unit 1020 may be structured to perform operations to manage processing schemes implementing a correlation of data or a statistical analysis of data in a manner similar to or identical to embodiments described herein.

Electronic apparatus 1065 may be used in conjunction with the controller 1025 to perform tasks associated with taking measurements downhole at least one sensor 1010 of at least one evaluation tool 1005. The communications unit 1040 may include downhole communications in a drilling operation. Such downhole communications may include a telemetry system.

The system 1000 may also include a bus 1027, where the bus 1027 provides electrical conductivity among at least two components of the system 1000. The bus 1027 may include an address bus, a data bus, or a control bus, each independently configured if more than one is present. The bus 1027 may also use common conductive lines for providing one or more of address, data, or control, the use of which may be regulated by the controller 1025. The bus 1027 may include an optical transmission medium to provide optical signals among two or more of the various components of system 1000. The bus 1027 may be configured such that the components of the system 1000 are distributed. The bus 1027 may include network capabilities. Such distribution may be arranged between downhole components such as at least one sensor 1010 of at least one evaluation tool 1005 and components that can be disposed on the surface of a well. Alternatively, various of these components may be co-located such as on one or more collars of a drill string, on a wireline structure, or in another measurement arrangement.

As used herein, the term “electromagnetic radiation” refers to radio waves, microwave radiation, infrared and near-infrared radiation, visible light, ultraviolet light, X-ray radiation and gamma ray radiation.

As used herein, the term “optically interact” or variations thereof refers to electromagnetic radiation that has been reflected, transmitted, scattered, diffracted, or absorbed by, emitted, or re-radiated, for example, using an integrated computational element, but may also apply to interaction with a substance, such as a fluid.

As used herein, the term “fluid” refers to any substance that is capable of flowing, including particulate solids, liquids, gases, slurries, emulsions, powders, muds, glasses, mixtures, combinations thereof, and the like. The fluid may be a single phase or a multiphase fluid. In some embodiments, the fluid can be an aqueous fluid, including water, brines, or the like. In other embodiments, the fluid may be a non-aqueous fluid, including organic compounds, more specifically, hydrocarbons, oil, a refined component of oil, petrochemical products, and the like. In some embodiments, the fluid can be acids, surfactants, biocides, bleaches, corrosion inhibitors, foamers and foaming agents, breakers, scavengers, stabilizers, clarifiers, detergents, a treatment fluid, fracturing fluid, a formation fluid, or any oilfield fluid, chemical, or substance as found in the oil and gas industry and generally known to those skilled in the art. The fluid may also have one or more solids or solid particulate substances entrained therein. For instance, fluids can include various flowable mixtures of solids, liquids and/or gases. Illustrative gases that can be considered fluids according to the present embodiments, include, for example, air, nitrogen, carbon dioxide, argon, helium, methane, ethane, butane, and other hydrocarbon gases, hydrogen sulfide, combinations thereof, and/or the like.

Because polycrystalline transparent ceramic components 40 may both be formed as single, integrated units, they are not subject to problems caused by the interface in sapphire/calcium fluoride components designed for similar purposes.

FIG. 3B shows a sensor component 100 containing polycrystalline transparent ceramic and a pressure-balanced fluid window 120. Pressure-balanced fluid window 120 may have the same cross-section as a flowline (not shown) also in the sensor and connected to sensor component 100 so that when fluid from the flowline passes through sensor component 100, there is no change in fluid velocity. Electromagnetic radiation passing through sensor component 100 may be directed through pressure-balanced fluid window 120, where it may optically interact with fluid passing through the window before traveling to a detector. The fluid's effects on the electromagnetic radiation may indicate properties of the fluid. The use of this design may also provide for easier services of seals located in or around the sensor.

FIG. 4 illustrates a cylinder in cross section containing polycrystalline transparent ceramic component 200 with grooves 210. Grooves 210 may accommodate O-rings (not shown). Other component configurations with grooves, indentations, or ridges to house other sensor elements, such as seals, may also be formed.

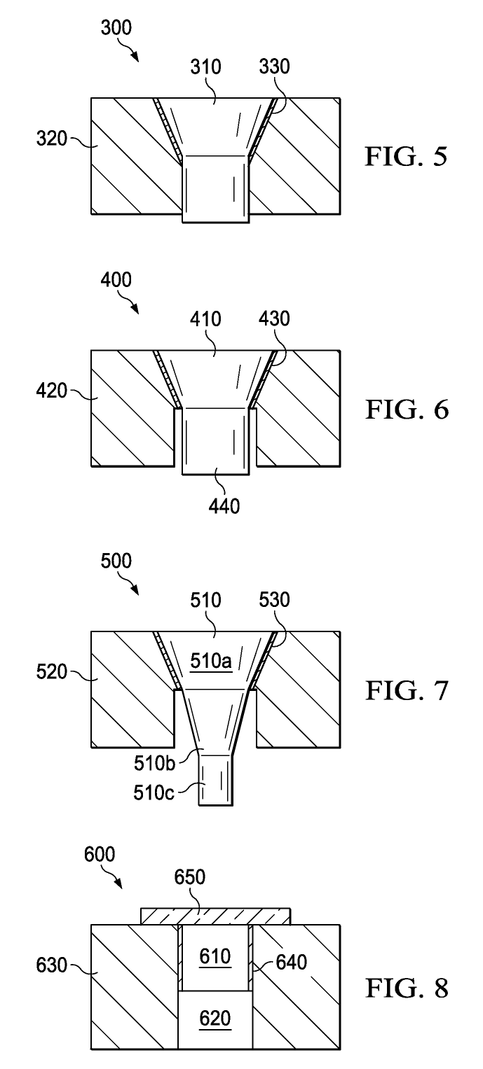

FIG. 5 illustrates a sensor 300 with polycrystalline transparent ceramic component 310 in housing 320. Brazing material 330 may be present along at least a portion of the interface between polycrystalline transparent ceramic component 310 and housing 320 to assist in holding component 310 in housing 320. Brazing material 330 may, optionally, also be absent. Brazing material 330 may include any brazing material suitable for downhole use. In specific embodiments, the brazing material may be a eutectic alloy system where in the alloy melting temperature is compatible with other components and the surface tension of the melted material is low enough to wet the components to be joined via capillary action. Brazing materials may include silver (Ag), copper (Cu), gold (Au), zinc (Zn), tin (Sn), nickel (Ni), aluminum (Al), or combinations thereof. Constituents of brazing materials may be varied to control melting temperature and wetting behavior. Silver (Ag), gold (Au) and copper (Cu) alloys may be particularly well-suited for downhole use because of their resistance to hydrogen sulfide (H₂S) damage. In the embodiment shown, component 310 may extend beyond housing 320 at one end in order to act as a pipe for electromagnetic radiation passing through housing 310.

FIG. 6 illustrates a sensor 400 with polycrystalline transparent ceramic component 410 in housing 420. Component 410 may be held in housing 420 through the assistance of brazing material 430 located along at least a portion of the interface between component 410 and housing 420. Brazing material 430 may, optionally, also be absent. Brazing material 430 may include any brazing material suitable for downhole use. Gaps 440 may be present between component 410 and housing 420 in areas where brazing material 430 is absent. These gaps 440 may help prevent misalignment of component 410 in housing 420 during the brazing process. Gaps 440 may also help reduce sensitivity of sensor 400, particularly component 410, to high pressure loads.

FIG. 7 illustrates a sensor 500 with polycrystalline transparent ceramic component 510 in housing 530. Brazing material 530 may be located along at least a portion of the interface between component 510 and housing 530 to help hold component 510 in housing 530. Brazing material 530 may, optionally, be absent, and, if present, may include any brazing material suitable for downhole use. Component 510 may be shaped to intensify electromagnetic radiation passing through it. For example, electromagnetic radiation may be intensified in region 510a, and homogenized in region 510b, before passing through end section 510c. A detector (not shown) may be placed close to end section 510c.

The use of these ALON components can improve optical throughput, and increase signal-to-noise ratio (SNR), in optical sensors by combining multiple optical elements into fewer optical elements. This increase in SNR may be accomplished by eliminating some optical interfaces, which cause reflection losses

Components with shapes such as those shown in FIGS. 5-8 may remain in place in their respective housings due to pressure from fluid passing along their surfaces.

FIG. 8 illustrates a sensor component 600, such as part of a logging sensor or tool, in which a sapphire component 610 and optionally, a calcium fluoride component 620 are housed in housing 630. Brazing material 640, which may be any brazing material suitable for downhole use, holds sapphire component 610 in housing 630. A polycrystalline transparent ceramic layer 650 is placed over the sapphire component 610 and brazing material 640. Layer 650 may prevent brazing material 640 from leaking at high temperatures or in the presence of corrosive materials downhole and therefore prevent brazing material 640 from clouding sapphire component 610. In an alternative embodiment, not shown, polycrystalline transparent ceramic layer 650 may cover only brazing material 640 and a portion of sapphire component 610, leaving the majority of sapphire component 610 exposed, but still preventing leaking of brazing material 640 in downhole conditions.

In still other embodiments, layers of polycrystalline transparent ceramic may be used to protect other elements downhole, for example by shielding the elements from corrosive materials such as hydrogen sulfide and carbon dioxide or by preventing physical erosion of the elements.

### Methods of Forming Polycrystalline Transparent Ceramic Components

In one embodiment, a polycrystalline transparent ceramic component may be formed by placing a power precursor in a sensor component, then performing a conventional process on the assembly. For example, to form a polycrystalline transparent ceramic component 40 as shown in FIG. 1, a powder precursor may be placed in housing 70, then subjected to a casting process such that the powder forms the polycrystalline transparent component 40 in situ. Additional bonding of the polycrystalline transparent component 40 to housing 70 may be unnecessary.

In another example, shown in FIG. 3, a sensor component 100 containing a polycrystalline transparent ceramic, such as ALON or magnesium aluminate spinel, may be formed with a pressure-balanced fluid window. As shown in FIG. 3A when sensor component 100 is formed a mandrel 110 made of a higher melting point material, such as a higher melting point ceramic, for example boron carbide, may be inserted in the powder that will form polycrystalline transparent ceramic before it is cast. Mandrel 100 may have a slight taper so that it may be removed from sensor component 100 after casing to form a pressure-balanced fluid window 120 as shown in FIG. 3B. The surfaces of pressure-balanced fluid window may require little or no polishing to be transparent to desired electromagnetic radiation. The sensor component 100 may be part of a flowline tool, such as a logging sensor or tool. Components such as sensor component 100 may not be formed from sapphire.

In another example, shown in FIG. 4, a sensor component 200 containing a polycrystalline transparent ceramic, such as ALON or magnesium aluminate spinel, may be formed in a shape with a groove, indentation, or ridge to house other sensor components, such as O-rings or other seals. The component may be cast in such a configuration, without the need for cutting or grinding to form such grooves, indentations, or ridges. Thus, the risk of shattering inherent when such features are formed in uncastable sapphire may be avoided.

In still another example, a polycrystalline transparent ceramic may be formed as a layer, such as shown in FIG. 8 or as a protective layer described above using a thick film deposition technique, such as reactive magnetron sputtering, chemical vapor deposition, or laser ablation. Additionally, particularly to obtain thicker layers, the surface to be protected by be coated with a powder precursor to the polycrystalline transparent ceramic then subjected to heat to form the polycrystalline transparent ceramic layer.

In another example, a polycrystalline transparent ceramic component may be machined or polished after casting. Polycrystalline transparent ceramics may be less prone to breakage during machining or polishing than sapphire, accordingly machining and polishing techniques not usable with sapphire may be used and polycrystalline transparent ceramics may be machined to a much greater degree than sapphire.

In a specific example, the sensor may contain or be connected to an optical computing device. Any optical computing device techniques may be used to analyze the data from the detector or sub-detectors. For example, a characteristic of a fluid passing through the sensor may be identified by a “fingerprint” modification of a variety of electromagnetic radiation wavelengths. Modifications of electromagnetic radiation wavelengths from known fluid components and interferents may be filtered from the detector data during this process.

Drilling Devices Containing Sensors with Polycrystalline Transparent Components

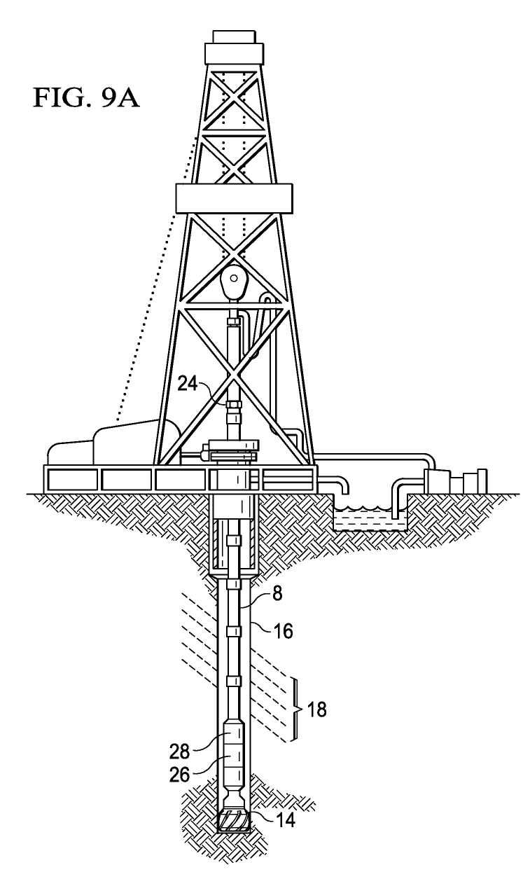

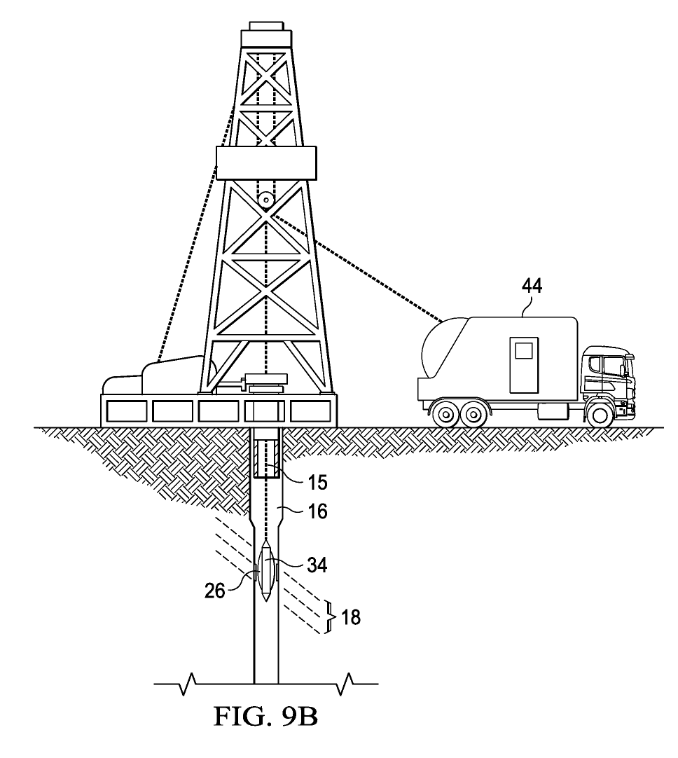

As shown in FIG. 9A, a logging tool 26 containing a polycrystalline transparent ceramic component may be integrated into the bottom-hole assembly near the bit 14 (e.g., within a drilling collar, i.e., a thick-walled tubular that provides weight and rigidity to aid in the drilling process, or a mandrel). In some embodiments, the logging tool 26 may be integrated at any point along the drill string 8. The logging tool 26 may include receivers and/or transmitters (e.g., antennas capable of receiving and/or transmitting one or more electromagnetic signals). In some embodiments, the logging tool 26 may include a transceiver array that functions as both a transmitter and a receiver. As the bit extends the borehole 16 through the formations 18, the logging tool 26 may collect measurements relating to various formation properties as well as the tool orientation and position and various other drilling conditions. The orientation measurements may be performed using an azimuthal orientation indicator, which may include magnetometers, inclinometers, and/or accelerometers, though other sensor types such as gyroscopes may be used in some embodiments. In embodiments including an azimuthal orientation indicator, resistivity and/or dielectric constant measurements may be associated with a particular azimuthal orientation (e.g., by azimuthal binning). A telemetry hub 28 may be included to transfer tool measurements to a surface receiver 24 or to receive commands from the surface receiver 24. The surface receiver may include a part of system 1000 as described in FIG. 2.

At various times during the drilling process, the drill string 8 may be removed from the borehole 16 as shown in FIG. 9B. Once the drill string has been removed, logging operations can be conducted using a wireline system 34, i.e., an instrument that is suspended into the borehole 16 by a cable 15 having conductors for transporting power to the system and telemetry from the system body to the surface. The wireline system 34 may include one or more logging sensors or tools 26 containing a polycrystalline transparent ceramic according to the present disclosure. The logging sensor or tool 26 may be communicatively coupled to the cable 15. A logging facility 44 (shown in FIG. 9B as a truck, although it may be any other structure) may collect measurements from the logging sensor or tool 26, and may include computing facilities (including, e.g., an information handling system or components described in FIG. 2) for controlling, processing, or storing the measurements gathered by the logging sensor or tool 26. The computing facilities may be communicate with the logging sensor or tool 26 by way of the cable 15. The computing facilities may include a part of system 1000 as described in FIG. 2.

Data from analyses of drilling fluid performed by logging sensor or tool 26 in FIGS. 9A or 9B may be handled as described with respect to FIG. 2 and may be used to control the operation of at least some of the drilling equipment. For example, it may be used to control a formation evaluation tool set, such as the Reservoir Description Tool™ (Halliburton, Tex.) for wireline operations and Geo tap for MWD and LWD operations. In such specific embodiments, fluids may be extracted either from the formation or the bore hole and pumped through a series of sensors within the logging sensor or tool 26. These sensors may characterize the fluids' physical properties, such as density, viscosity, phases (gas, liquid, slurry, etc.), electrical properties, impedance, resistivity, and capacitance. The composition may also be determined using optical sensors. The tool set may also allow capture of the fluid downhole, which may later be analyzed at the surface. For downhole tools, the data from optical sensors may be transmitted to the surface by telemetry through wires, acoustical pulses into the mud, or electromagnetic pulses. In many cases the data may be stored with in the tool set so a more complete record of observation may be recovered once the tool set has returned to surface.

Although only exemplary embodiments of the invention are specifically described above, it will be appreciated that modifications and variations of these examples are possible without departing from the spirit and intended scope of the invention.

1. A logging sensor or tool comprising:
an electromagnetic radiation source operable to emit at least one wavelength of electromagnetic radiation;
a detector operable to detect the at least one wavelength of electromagnetic radiation;
a polycrystalline transparent ceramic component transparent to the at least one wavelength of radiation; and
a flowline between the electromagnetic radiation source and the detector having at least a portion of a wall formed from the polycrystalline transparent ceramic component, the flow line operable to permit the flow of a drilling fluid.

2. The sensor of claim 1, wherein the polycrystalline transparent ceramic component comprises polycrystalline aluminum oxynitride (ALON).

3. The sensor of claim 1, wherein the polycrystalline transparent ceramic component comprises magnesium aluminate spinel.

4. The sensor of claim 1, wherein the at least one wavelength of radiation has a wavelength of between 10 nm and 7000 nm.

6. The sensor of claim 1, wherein the detector produces data operable to be used to analyze a property of the drilling fluid.

7. The sensor of claim 1, wherein the detector comprises or is in communication with a processor and data storage device as well as an output device.

8. The sensor of claim 1, wherein the electromagnetic radiation source is operable to emit at least two wavelengths of electromagnetic radiation, the detector is operable to detect the at least two wavelengths of electromagnetic radiation, and the polycrystalline transparent ceramic is transparent to the at least two wavelengths of radiation.

9. The sensor of claim 6, wherein the property is determined using an integrated computational element (ICE).

10. The sensor of claim 1, wherein the polycrystalline ceramic component comprises a layer located over a sapphire component and a brazing material.

11. A wireline system comprising:
a cable; and
a logging sensor or tool communicatively coupled to the cable, the logging sensor or tool comprising a sensor comprising a polycrystalline transparent ceramic component.

12. The system of claim 11, wherein the polycrystalline transparent ceramic component comprises polycrystalline aluminum oxynitride (ALON).

13. The system of claim 11, wherein the polycrystalline transparent ceramic component comprises magnesium aluminate spinel.

14. A logging-while-drilling (LWD) system comprising:
a bit;
a drill string; and
a logging sensor or tool integrated along the drill string, the logging sensor or tool comprising:
an electromagnetic radiation source operable to emit at least one wavelength of electromagnetic radiation;
a detector operable to detect the at least one wavelength of electromagnetic radiation;
a polycrystalline transparent ceramic component transparent to the at least one wavelength of radiation; and
a flowline between the electromagnetic radiation source and the detector having at least a portion of a wall formed from the polycrystalline transparent ceramic component, the flow line operable to permit the flow of a drilling fluid.

15. The system of claim 14, wherein the polycrystalline transparent ceramic component comprises polycrystalline aluminum oxynitride (ALON).

16. The system of claim 14, wherein the polycrystalline transparent ceramic component comprises magnesium aluminate spinel.

17. A cast logging sensor or tool component comprising a polycrystalline transparent ceramic component, wherein the sensor component has a shape not obtainable from a single crystal using machining techniques.

18. The component of claim 17, wherein the polycrystalline transparent ceramic component comprises polycrystalline aluminum oxynitride (ALON).

19. The component of claim 17, wherein the polycrystalline transparent ceramic component comprises magnesium aluminate spinel.

20. The component of claim 17, wherein the polycrystalline transparent ceramic component comprises an intensification region and a homogenization region.
